(19) United States
(12) Patent Application Publication
(10) Pub. No.: US 2018/0015973 A1
(43) Pub. Date: Jan. 18, 2018

(54) METHOD AND APPARATUS FOR MOUNTING FRONT END MODULE

(71) Applicant: HONDA MOTOR CO., LTD., Tokyo (JP)

(72) Inventors: Nobuhiro Nanba, Tochigi-ken (JP); Hitoe Yoshimoto, Tochigi-ken (JP); Hirofumi Kimura, Tochigi-ken (JP)

(21) Appl. No.: 15/646,859

(22) Filed: Jul. 11, 2017

(30) Foreign Application Priority Data
Jul. 15, 2016 (JP) 2016-140479

(51) Int. Cl. B62D 65/02; B25J 9/16; B62D 65/16

(52) U.S. Cl. CPC B62D 65/028; B62D 65/16; B25J 9/1687; B62D 65/026

(57) ABSTRACT

Sensing units, nut runners, and position adjusting members are provided for respective front end arms of a first position adjusting robot and a second position adjusting robot. First, the position of a vehicle body is determined by the sensing units of the first position adjusting robot and the second position adjusting robot. The first position adjusting robot and the second position adjusting robot move a front end module by the position adjusting members to a position where the front end module can move into an opening in a front part of the vehicle body, based on the positional information of the vehicle body.

### CROSS-REFERENCE TO RELATED APPLICATION

This application is based upon and claims the benefit of priority from Japanese Patent Application No. 2016-140479 filed on Jul. 15, 2016, the contents of which are incorporated herein by reference.

### BACKGROUND OF THE INVENTION

### Field of the Invention

The present invention relates to a method of, and an apparatus for mounting a front end module to a vehicle body.

### Description of the Related Art

At the time of producing an automobile, a front end module may be mounted to a vehicle body having a large opening in its front part (e.g., see Japanese Patent No. 3747811). In this regard, the front end module is an assembly including a front bumper, a front bumper beam, head lights, a front grille, etc. In this state, the front end module is transported to a station for mounting the front end module to the vehicle body.

For mounting the front end module to the vehicle body, firstly, the front end module is moved into an opening formed in the front part of the vehicle body. At this time, when a relative positional displacement between the vehicle body and the front end module occurs in a width direction of the vehicle body, it is difficult to move the front end module into the opening. With a view to overcoming the problem, in Japanese Patent No. 3765254, it is proposed to provide a position adjustment mechanism which makes it possible to adjust the position of the front end module.

### SUMMARY OF THE INVENTION

In the technique described in Japanese Patent No. 3765254, operation of adjusting the position of the front end module using the position adjusting mechanism is carried out by an operator. Stated otherwise, such operation is performed manually by manpower, and is a laborious burden on the operator.

A main object of the present invention is to provide a method of mounting a front end module which makes it possible to perform positional adjustment of the front end module relative to the vehicle body, and the subsequent tightening of the front end module to the vehicle body automatically.

Another object of the present invention is to provide a method of mounting a front end module which makes it possible to reduce the burden on the operator.

Another object of the present invention is to provide a mounting apparatus for carrying out the above mounting method.

According to an embodiment of the present invention, a method of mounting a front end module to a vehicle body is provided. The front end module includes a front bumper and head lights. The method includes the steps of holding the front end module by a holding jig provided for a holding robot, and transferring the front end module to the vehicle body, adjusting a position of the front end module in a width direction by a first position adjusting robot and a second position adjusting robot based on positional information of the vehicle body acquired by a positional information acquisition mechanism, in a manner to enable the front end module held by the holding robot to move into a mounting space formed in a front part of the vehicle body, moving the front end module whose position has been adjusted into the mounting space, and tightening the front end module to the vehicle body using nut runners provided for the first position adjusting robot and the second position adjusting robot, respectively.

According to another embodiment of the present invention, a front end module mounting apparatus for mounting a front end module to a vehicle body is provided. The front end module includes a front bumper and head lights. The front end module mounting apparatus includes a holding robot including a holding jig configured to hold the front end module, a positional information acquisition mechanism, and a first position adjusting robot and a second position adjusting robot configured to adjust a position of the front end module in a width direction based on positional information of the vehicle body acquired by the positional information acquisition mechanism in a manner to enable the front end module held by the holding robot to move into a mounting space formed in a front part of the vehicle body.

Each of the first position adjusting robot and the second position adjusting robot has a nut runner configured to tighten the front end module which has moved into the mounting space, to the vehicle body.

As described above, in the present invention, the positional alignment of the front end module with the vehicle body is performed automatically by the first position adjusting robot and the second position adjusting robot. Therefore, the burden on the operator is reduced. Further, the first position adjusting robot and the second position adjusting robot serve as tightening robots for tightening the front end module to the vehicle body (robots for tightening nuts). In the structure, since there is no need to additionally provide any position adjusting robot and tightening robot, it is possible to avoid the increase in the capital investment, and simplify the structure of the mounting apparatus.

It should be noted that the left and right head lights are heavy. Therefore, there is a concern that a downward positional displacement in the front end module may occur due to the weight of the front end module itself, in the process of making the positional adjustment of the front end module and moving the front end module into the opening. Preferably, a head light support is provided for the holding jig, and the head light is supported by the head light support from below. It is because the downward positional displacement of the head light can be avoided by supporting of the head light in this manner.

Further, at the time of adjusting the position of the front end module in the width direction, the front end module may be pressed by one of the first position adjusting robot and the second position adjusting robot, and movement of the front end module may be stopped by another of the first position adjusting robot and the second position adjusting robot. By the simple operation, it is possible to make the positional alignment between the front end module and the vehicle body.

In the present invention, the tightening robot for tightening the front end module to the vehicle body is also used as the position adjusting robot for making the positional alignment between the front end module and the vehicle body. Therefore, with the small capital investment and simple structure, it is possible to make the positional alignment automatically. Further, the burden on the operator for this purpose is reduced.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view schematically showing main components of a vehicle body and a front end module;

FIG. 2 is an enlarged perspective view showing main components of the vehicle body and the front end module in which a portion around a left head light of the front end module is enlarged;

FIG. 3 is a plan view schematically showing an apparatus for mounting a front end module according to an embodiment of the present invention;

FIG. 4 is a side view schematically showing main components of a holding jig provided for a holding robot of the mounting apparatus of FIG. 3 and the front end module; and

FIG. 5 is a plan view schematically showing main components of a position adjusting member provided for a first position adjusting robot and a second position adjusting robot of the mounting apparatus of FIG. 3 and the front end module.

### DESCRIPTION OF THE PREFERRED EMBODIMENTS

Hereinafter, a preferred embodiment of a method of mounting a front end module according to the present invention will be described in detail in relation to an apparatus for carrying out the mounting method, with reference to the accompanying drawings. In the following description, unless otherwise specified, “front”, “rear”, “right”, and “left” indicate the forward direction, the backward direction, the right side direction, and the left side direction, respectively, as viewed from a driver seated on a driver's seat.

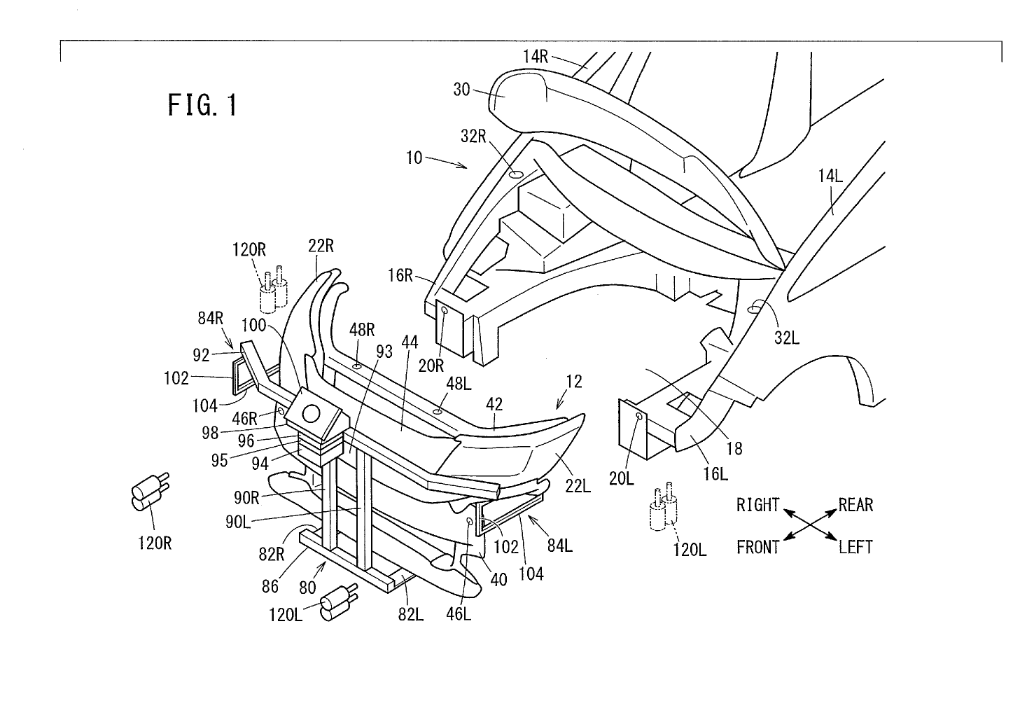

Firstly, a vehicle body 10 and a front end module 12 will be described briefly with reference to FIG. 1. The vehicle body 10 includes a left front side member 16L and a right front side member 16R on its front side. The left front side member 16L protrudes from a left A-pillar 14L, and the right front side member 16R protrudes from a right A-pillar 14R. In this case, no front cross member is provided between the left front side member 16L and the right front side member 16R. Therefore, a large opening 18 is formed between the left front side member 16L and the right front side member 16R. The opening 18 serves as a mounting space for mounting the front end module 12.

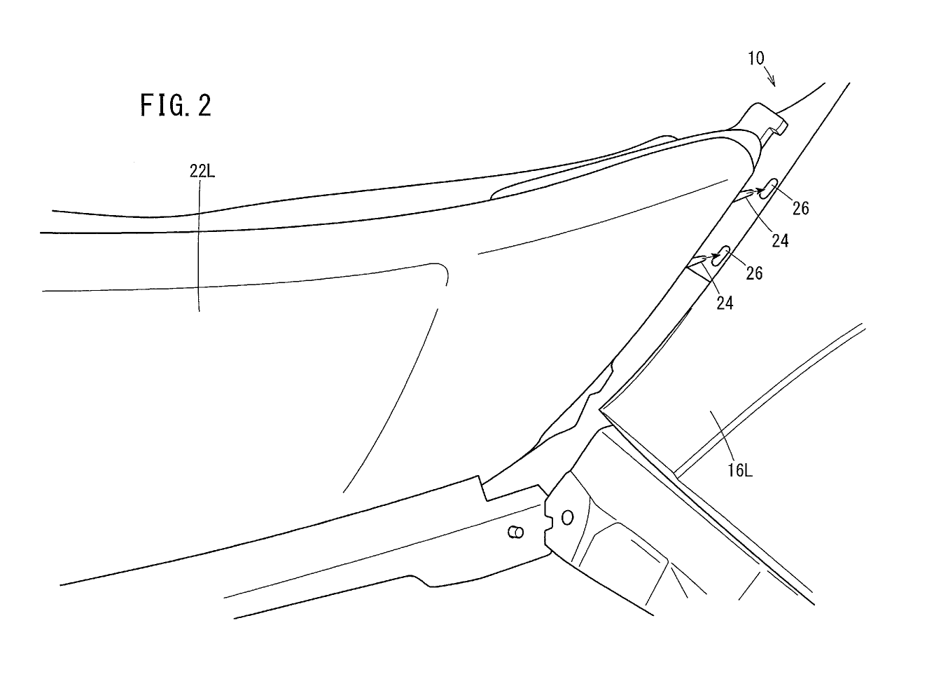

A left front surface bolt hole 20L, a right front surface bolt hole 20R, and pin holes 26 are formed on front end surfaces of the left front side member 16L and the right front side member 16R, respectively. Hooking pins 24 (see FIG. 2) provided for a left head light 22L and a right head light 22R are inserted into the pin holes 26. In FIG. 2, only the pin holes 26 and the hooking pins 24 on the part of the left head light 22L are shown.

A left upper surface bolt hole 32L and a right upper surface bolt hole 32R are formed respectively on upper end surfaces of the left front side member 16L and the right front side member 16R covered by a bonnet 30 (see FIG. 1). The left upper surface bolt hole 32L, the right upper surface bolt hole 32R, the left front surface bolt hole 20L, and the right front surface bolt hole 20R are reference positions for detecting the position of the vehicle body 10. The front end module 12 is an assembly including a front bumper 40, a front bumper beam 42, the left head light 22L, the right head light 22R, a front grille 44, etc. A left bolt insertion hole 46L and a right bolt insertion hole 46R are formed in the front bumper 40. The left bolt insertion hole 46L and the right bolt insertion hole 46R are overlapped with the left front surface bolt hole 20L and the right front surface bolt hole 20R, respectively. Further, a left upper bolt insertion hole 48L and a right upper bolt insertion hole 48R are formed in the front bumper beam 42. The left upper bolt insertion hole 48L and the right upper bolt insertion hole 48R are overlapped with the left upper surface bolt hole 32L and the right upper surface bolt hole 32R, respectively.

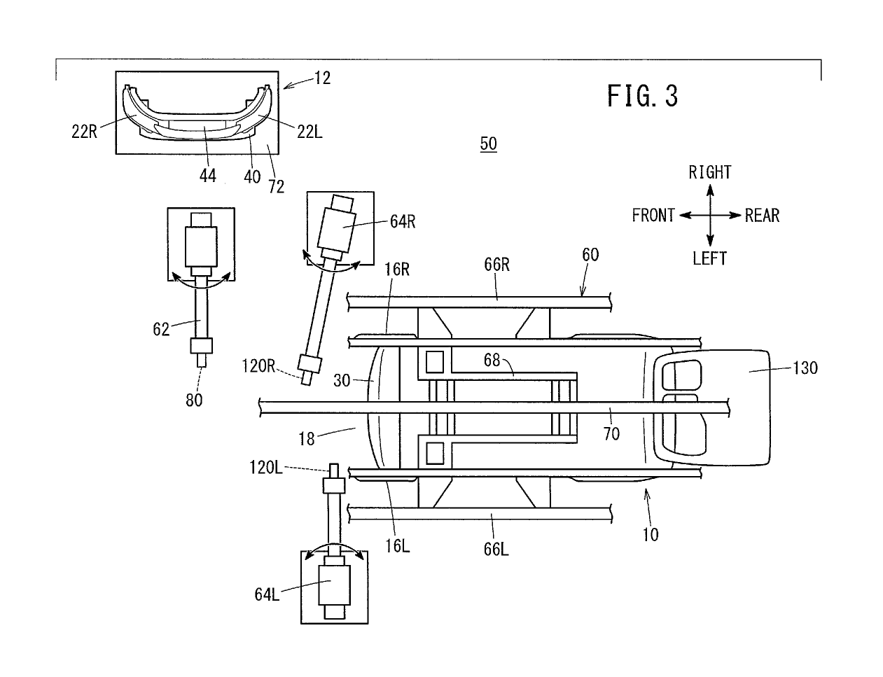

The front end module 12 and the vehicle body 10 are produced in different working stations, and transferred to an apparatus 50 for mounting the front end module 12 shown in FIG. 3 (hereinafter also simply referred to as the “mounting apparatus”). Thereafter, as described later, the front end module 12 is mounted to the front part of the vehicle body 10.

Next, the mounting apparatus 50 according to the embodiment of the present invention will be described with reference to FIGS. 1 and 3 to 5. FIG. 3 is a plan view schematically showing main components of the mounting apparatus 50. The mounting apparatus 50 includes a transportation mechanism 60 for suspending and transporting the vehicle body 10, and three robots 62, 64L, and 64R.

The transportation mechanism 60 includes guide rails 66L, 66R extending in parallel at left upper and right upper positions of the vehicle body 10, and a suspension rail 70 for supporting a hanger 68 which suspends the vehicle body 10, through a drive slider (not shown). A plurality of driven wheels (not shown) engaged slidably with the guide rails 66L, 66R are provided for the hanger 68. In the structure, the drive slider is displaced along the suspension rail 70, and consequently, the hanger 68 and the vehicle body 10 are displaced along the guide rails. In FIG. 3, the traveling direction of the vehicle body 10 is the left side of FIG. 3.

The three robots 62, 64L, 64R are general purpose multi-joint robots, e.g., having six axes. These three robots 62, 64L, and 64R are provided at positions which do not obstruct movement of the vehicle body 10.

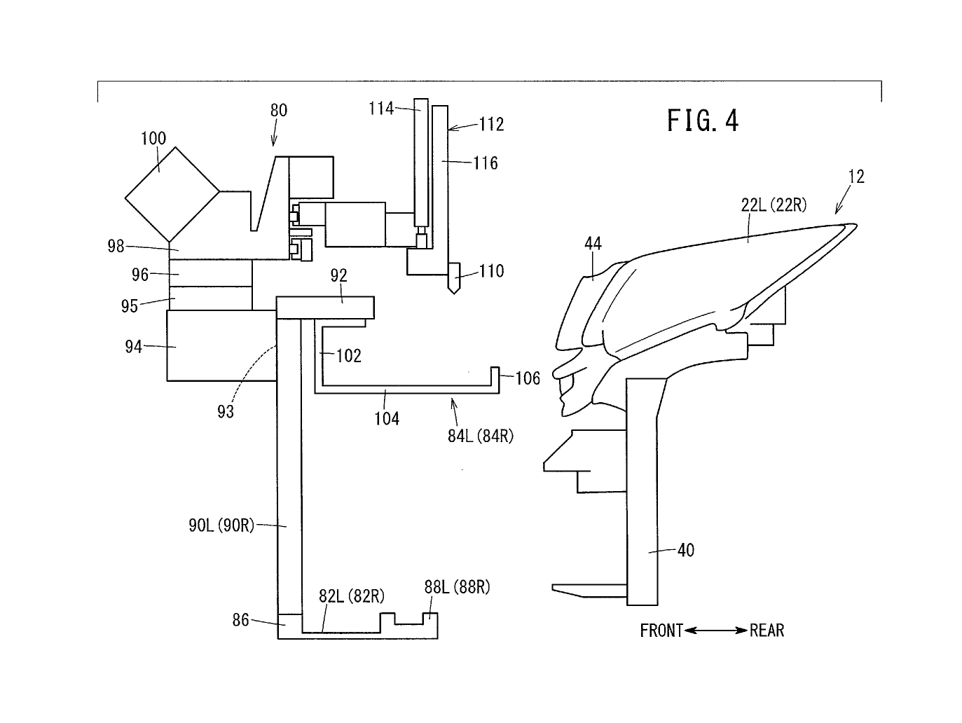

One of the three robots is the holding robot 62 for holding one of a plurality of front end modules 12 provided temporarily in a stock yard 72, and transporting the front end module 12 to the vehicle body 10. In the stock yard 72, the front end module 12 is supported on a support frame (not shown). As shown in FIG. 4, the front end module 12 stands upright where the front bumper 40 is positioned on the lower side, and the left head light 22L, the front grille 44, and the right head light 22R are positioned on the upper side.

A holding jig 80 shown in FIGS. 1 and 4 is provided at a front end arm of the holding robot 62. The holding jig 80 includes two bumper supports 82L, 82R for supporting the front bumper 40 from below, an LHD support (left head light support) 84L for supporting the left head light 22L, and an RHD support (right head light support) 84R for supporting the right head light 22R.

The bumper supports 82L, 82R are formed integrally with a bridge 86 extending in the width direction of the vehicle body, and extends from a front position to a rear position. Engagement parts 88L, 88R (see FIG. 4) are provided at rear ends of the bumper supports 82L, 82R. The front bumper 40 is supported by inserting a lower end of the front bumper 40 into the engagement parts 88L, 88R. Further, two cylindrical columns 90L, 90R (see FIG. 1) stand upright from the bridge 86. A support bar 92 extending substantially in parallel to the bridge 86 is provided at upper front ends of the cylindrical columns 90L, 90R.

A panel member 93 is provided at the upper front ends of the cylindrical columns 90L, 90R in a manner that the panel member 93 is surrounded by the cylindrical columns 90L, 90R and the support bar 92. A first stay 94, a second stay 95, and a third stay 96 are provided for the panel member 93. Further, a first bracket 98 is attached to the third stay 96, and a second bracket 100 is provided for the first bracket 98. A front end arm of the holding robot 62 is coupled to the second bracket 100.

A left end and a right end of the support bar 92 are slightly bent in correspondence with inclination of the left head light 22L and the right head light 22R relative to the front grille 44. The LHD support 84L and the RHD support 84R are provided at the bent left and right ends of the support bar 92, respectively.

The LHD support 84L includes a hanging part 102 hanging vertically downward from a lower end surface at the left end of the support bar 92, and a horizontal part 104 extending backward from the hanging part 102. A bent protrusion 106 oriented upward protrudes from an end of the horizontal part 104 (see FIG. 4). The protrusion 106 supports the left head light 22L from below. The RHD support 84R has the same structure as the LHD support 84L. Therefore, the constituent components of the RHD support 84R that are identical to those of the LHD support 84L are labeled with the same reference characters, and detailed description is omitted.

The first bracket 98 includes a holder part 112 having a reference pin 110. The holder part 112 has a displaceable panel 116 which can be displaced vertically under operation of an air cylinder 114. The displaceable panel 116 is provided with the reference pin 110.

The two robots other than the holding robot 62 are a first position adjusting robot 64L and a second position adjusting robot 64R. As described later, the first position adjusting robot 64L and the second position adjusting robot 64R make a positional adjustment to align the position of the front end module 12 with the position of the vehicle body 10.

Nut runners 120L, 120R are provided at front end arms of the first position adjusting robot 64L and the second position adjusting robot 64R. The nut runners 120L, 120R have functions of rotating nuts (not shown) with respect to bolts inserted into predetermined bolt insertion holes and bolt holes described above. That is, the first position adjusting robot 64L and the second position adjusting robot 64R also function as tightening robots.

The first position adjusting robot 64L and the second position adjusting robot 64R are operated in an appropriate manner to change the position of the front arms. In accordance with this change, the pose of the nut runners 120L, 120R is changed from a tightening pose where the nut runners 120L, 120R extend from the front to rear positions of the vehicle body 10 as denoted by solid lines in FIG. 1, to the position where the nut runners 120L, 120R extend from lower to upper positions as denoted by imaginary lines.

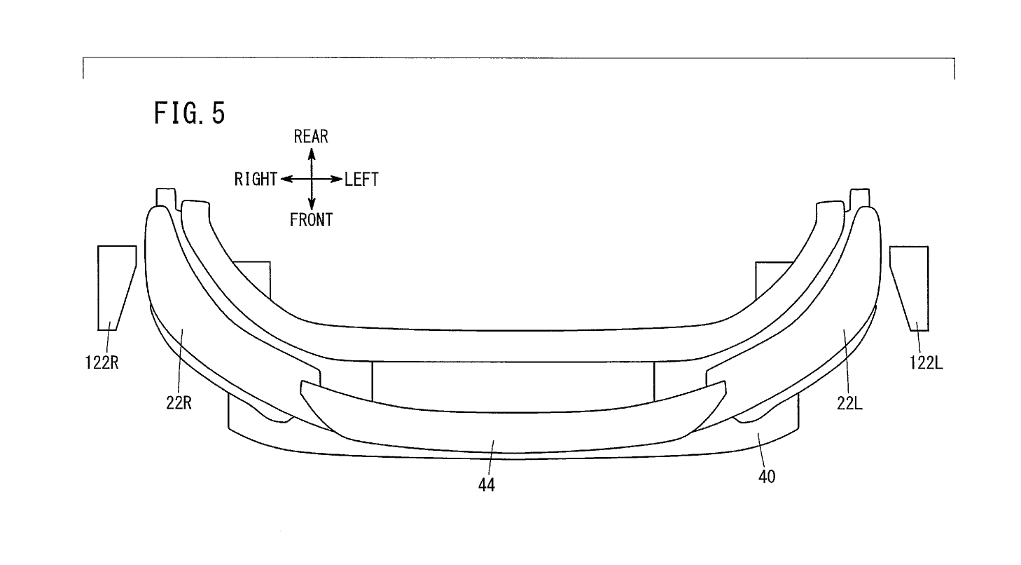

Position adjusting members 122L, 122R shown in FIG. 5 are provided at respective front arms of the first position adjusting robot 64L and the second position adjusting robot 64R. When the nut runners 120L, 120R take the position adjusting pose, these position adjusting members 122L, 122R face positions slightly below the side portions of the left head light 22L and the right head light 22R. When the nut runners 120L, 120R take the tightening pose, these position adjusting members 122L, 122R face the outside of the vehicle body 10 in the width direction.

Sensing units (not shown) (positional information acquisition mechanisms) are provided at the front end arms, respectively. Mainly, the sensing units detect the left upper surface bolt hole 32L, the right upper surface bolt hole 32R, the left front surface bolt hole 20L, and the right front surface bolt hole 20R formed in the vehicle body 10.

In the above structure, the drive slider, the holding robot 62, the first position adjusting robot 64L, the second position adjusting robot 64R, the reference pin 110, the sensing units, the nut runners 120L, 120R, etc. are electrically connected to a control unit (not shown).

The mounting apparatus 50 according to the embodiment of the present invention basically has the structure as described above. Next, effects and advantages of the mounting apparatus 50 will be described in relation to the method of mounting the front end module 12 according to the present invention. The following steps and operations are performed under control operation of the control unit.

As described above, the front end module 12 and the vehicle body 10 are produced in different working stations. In the state where the front end module 12 is supported by a support frame (not shown), the front end module 12 is provided temporarily in the stock yard 72 to stand upright, and the vehicle body 10 is suspended by the hanger 68. When the drive slider provided for the hanger 68 is driven, the drive slider is displaced along the suspension rail 70, and the driven wheels are displaced along the guide rails 66L, 66R. As a result, the hanger 68 and the vehicle body 10 held by the hanger 68 move slowly toward the left side (front side) in FIG. 3. At this time, the bonnet 30 and a rear hatch 130 are opened.

When the vehicle body 10 reaches a predetermined position (mounting position), the vehicle body 10 is stopped as necessary. In the meanwhile, the arm part of the holding robot 62 is turned, and the front end arm of the holding robot 62 faces the stock yard 72 as shown in FIG. 4. Then, the front end arm is operated in an appropriate manner to move the bumper supports 82L, 82R into positions below the front bumper 40, and cause the front bumper 40 to be inserted into the engagement parts 88L, 88R.

At the same time, the LHD support 84L moves into a position below the left head light 22L, and the RHD support 84R moves into a position below the right head light 22R.

Then, an upper end surface of the protrusion 106 contacts lower positions of the left head light 22L and the right head light 22R. In this manner, the left head light 22L and the right head light 22R are supported from below. Then, the air cylinder 114 is operated, and the rod of the air cylinder 114 is extended downward. Thus, the reference pin 110 is lowered, and contacts a predetermined position of the front end module 12. As a result, the front end module 12 is held by the holder part 112, and at the same time, it is detected whether or not the reference pin 110 is present at a predetermined reference position. If the reference pin 110 is present at the reference position, the control unit recognizes that “the front end module 12 has been held by the holding jig 80.”

In the meanwhile, the first position adjusting robot 64L and the second position adjusting robot 64R are operated in an appropriate manner. At this time, the positions of the left upper surface bolt hole 32L, the right upper surface bolt hole 32R, the left front surface bolt hole 20L, and the right front surface bolt hole 20R formed in the vehicle body 10 are detected by the sensing units. The control unit which has received these positions as information determines the position of the vehicle body 10.

Thereafter, the arm part of the holding robot 62 is turned, and as shown in FIG. 1, the front end module 12 is transported in a manner that the rear side of the front end module 12 is provided on the front side of the vehicle body 10. Stated otherwise, the front end module 12 is provided in the opening 18 between the left front side member 16L and the right front side member 16R.

In this regard, when no positional displacement occurs in the vehicle body 10, the left front surface bolt hole 20L, and the right front surface bolt hole 20R are overlapped with the left bolt insertion hole 46L and the right bolt insertion hole 46R formed in the front bumper 40, respectively. In contrast, in the case where the control unit recognizes that a positional displacement has occurred in the vehicle body 10 based on the positional information determined above, a positional alignment is made to align the position of the left front surface bolt hole 20L with the position of the left bolt insertion hole 46L, and align the position of the right front surface bolt hole 20R with the position of the right bolt insertion hole 46R.

That is, in the case where the control unit recognizes that the vehicle body 10 is deviated from the reference position toward the left or right (positional displacement has occurred), the control unit makes a positional adjustment of the front end module 12 by the first position adjusting robot 64L and the second position adjusting robot 64R. Specifically, each of the arm parts is operated in an appropriate manner, and consequently, the nut runners 120L, 120R take the position adjustment pose as shown by the imaginary lines in FIG. 1. Thus, as shown in FIG. 5, the position adjusting member 122L provided at the front end arm of the first position adjusting robot 64L faces a position slightly below the side portion of the left head light 22L, and the position adjusting member 122R provided at the front end arm of the second position adjusting robot 64R faces a position slightly below the side portion of the right head light 22R.

For example, in the case where the vehicle body 10 is deviated from the reference position to the right, the arm part of the first position adjusting robot 64L moves closer to the left head light 22L. As a result, the position adjusting member 122L contacts a position slightly below the side portion of the left head light 22L, and presses the position toward the second position adjusting robot 64R. By this pressing, the front end module 12 moves to the right. After the movement, the front end module 12 contacts the position adjusting member 122R of the second position adjusting robot 64R.

Conversely, in the case where the vehicle body 10 is deviated from the reference position to the left, the arm part of the second position adjusting robot 64R moves closer to the right head light 22R. Accordingly, the position adjusting member 122R contacts a position slightly below the side portion of the right head light 22R, and presses the position toward the first position adjusting robot 64L. As a result, the front end module 12 moves to the left. After the movement, the front end module 12 contacts the position adjusting member 122L of the first position adjusting robot 64L.

By this contact, further movement of the front end module 12 is prevented. Stated otherwise, movement of the front end module 12 is stopped by the position adjusting member 122R or the position adjusting member 122L. Thus, the front end module 12 is positioned in a manner that the left front surface bolt hole 20L is overlapped with the left bolt insertion hole 46L, and the right front surface bolt hole 20R is overlapped with the right bolt insertion hole 46R.

Next, the front end arm of the holding robot 62 moves further closer to the vehicle body 10. As described above, since the position of the front end module 12 is in alignment with the position of the vehicle body 10, the front end module 12 moves into the opening 18 of the vehicle body 10 without any interference with the left side member or the right side member. As a result, the left front surface bolt hole 20L is overlapped with the left bolt insertion hole 46L, and the right front surface bolt hole 20R is overlapped with the right bolt insertion hole 46R. At this time, the left upper surface bolt hole 32L is overlapped with the left upper bolt insertion hole 48L, and the right upper bolt insertion hole 48R is overlapped with the right upper surface bolt hole 32R.

Further, since the left head light 22L and the right head light 22R are supported by the LHD support 84L and the RHD support 84R, respectively, it is possible to prevent occurrence of the downward positional displacement in the left head light 22L and the right head light 22R due to their own weights. Therefore, the hooking pins 24 shown in FIG. 2 are inserted into the pin holes 26, and the front end module 12 is fixedly positioned to the vehicle body 10.

Next, bolts are inserted into the left front surface bolt hole 20L and the left bolt insertion hole 46L that are overlapped with each other, and the right front surface bolt hole 20R and the right bolt insertion hole 46R that are overlapped with each other, respectively. Further, the arm parts of the first position adjusting robot 64L and the second position adjusting robot 64R are operated in an appropriate manner to allow the nut runners 120L, 120R to take the tightening pose. Further, the nut runners 120L, 120R tighten nuts (not shown) to the bolts.

Further, bolts are also inserted into the left upper surface bolt hole 32L and the left upper bolt insertion hole 48L, and the right upper bolt insertion hole 48R and the right upper surface bolt hole 32R, respectively. Nuts are also tightened to these bolts by the nut runners 120L, 120R provided for the first position adjusting robot 64L and the second position adjusting robot 64R. By the above tightening operation, the front end module 12 is mounted to the vehicle body 10.

As described above, in the embodiment of the present invention, the relative positional alignment of the front end module 12 with the vehicle body 10 is made automatically by the first position adjusting robot 64L and the second position adjusting robot 64R. Accordingly, it is possible to reduce the burden on the operator.

Further, the first position adjusting robot 64L and the second position adjusting robot 64R have the function of tightening the front end module 12 to the vehicle body 10. Therefore, increase in the number of robots is avoided. Accordingly, it is possible to reduce the capital investment, and simplify the structure of the mounting apparatus 50.

Vehicles of different types or models have different vehicle widths and different mounting positions of the left head light 22L, the right head light 22R, etc. Therefore, preferably, the bumper supports 82L, 82R of the holding jig 80 and the support bar 92 should be changed to have the dimensions/shape in accordance with the vehicle types or models. In this manner, the holding jig 80 can have an excellent versatility.

The present invention is not limited specially to the above described embodiment, and various modifications can be made without deviating from the gist of the present invention.

For example, the front end module 12 may be pressed or stopped by the nut runners 120L, 120R, etc. without providing the position adjusting members 122L, 122R.

What is claimed is:

1. A method of mounting a front end module to a vehicle body, the front end module comprising a front bumper and head lights, the method comprising the steps of:
holding the front end module by a holding jig provided for a holding robot, and transferring the front end module to the vehicle body;
adjusting a position of the front end module in a width direction by a first position adjusting robot and a second position adjusting robot based on positional information of the vehicle body acquired by a positional information acquisition mechanism, in a manner to enable the front end module held by the holding robot to move into a mounting space formed in a front part of the vehicle body;
moving the front end module whose position has been adjusted into the mounting space; and
tightening the front end module to the vehicle body using nut runners provided for the first position adjusting robot and the second position adjusting robot, respectively.

2. The mounting method according to claim 1, wherein, while the front end module is held by the holding jig, the head lights are supported from below by a head light support of the holding jig.

3. The mounting method according to claim 1, for adjusting the position of the front end module in the width direction, the front end module is pressed by one of the first position adjusting robot and the second position adjusting robot, and movement of the front end module is stopped by another of the first position adjusting robot and the second position adjusting robot.

4. A front end module mounting apparatus for mounting a front end module to a vehicle body, the front end module comprising a front bumper and head lights, the front end module mounting apparatus comprising:
a holding robot including a holding jig configured to hold the front end module;
a positional information acquisition mechanism; and
a first position adjusting robot and a second position adjusting robot configured to adjust a position of the front end module in a width direction based on positional information of the vehicle body acquired by the positional information acquisition mechanism, in a manner to enable the front end module held by the holding robot to move into a mounting space formed in a front part of the vehicle body,
wherein each of the first position adjusting robot and the second position adjusting robot has a nut runner configured to tighten the front end module which has moved into the mounting space to the vehicle body.

5. The mounting apparatus according to claim 4, wherein the holding jig comprises a head light support configured to support the head lights from below.

6. The mounting apparatus according to claim 4, one of the first position adjusting robot and the second position adjusting robot is configured to press the front end module, and another of the first position adjusting robot and the second position adjusting robot is configured to stop movement of the front end module to adjust the position of the front end module in the width direction.

7. The mounting apparatus according to claim 4, wherein a position adjusting member configured to adjust the position of the front end module in the width direction is provided for each of the first position adjusting robot and the second position adjusting robot.

8. The mounting apparatus according to claim 4, wherein the holding jig includes a bumper support configured to support the front bumper from below.
